(19) United States
(12) Patent Application Publication
(10) Pub. No.: US 2015/0266121 A1
(43) Pub. Date: Sep. 24, 2015

(54) GEAR GRINDING APPARATUS PROVIDING TOOL MODIFICATION FUNCTION

(71) Applicant: LUREN PRECISION CO., LTD., HSINCHU CITY (TW)

(72) Inventors: SHI-DUANG CHEN, Hsinchu City (TW); TAY-CHENG KUO, Hsinchu City (TW)

(73) Assignee: LUREN PRECISION CO., LTD., HSINCHU CITY (TW)

(21) Appl. No.: 14/219,619

(22) Filed: Mar. 19, 2014

(51) Int. Cl. B23F 23/12; B23F 5/02

(52) U.S. Cl. CPC B23F 23/1225; B23F 5/02

(57) ABSTRACT

A gear grinding apparatus comprises a work-piece stand, a tool stand, a grinding wheel assembly and a modification assembly. The work-piece stand has a first shaft to hold and rotate an unmodified gear. The tool stand is movable along a first axial direction against the work-piece stand and includes a slide member. The grinding wheel assembly is located on the slide member to grind the unmodified gear. The modification assembly is located on the slide member above the grinding wheel assembly and includes a rotary member rotatably mounted on the slide member and having a second shaft rotatable about an axis intersecting the second axial direction at an angle smaller than ninety degrees, a trimmer and a movable arm interposed between the rotary member and trimmer. The trimmer has an oblique deviation displacement and a tool modification displacement. The invention formed can reduce production cost and shrink apparatus size.

### FIELD OF THE INVENTION

The present invention relates to a gear grinding apparatus and particularly to a gear grinding apparatus that provides tool modification function.

### BACKGROUND OF THE INVENTION

Gears are fundamental elements for transmitting driving power and movement. They have many advantages such as higher transmission efficiency, longer lifespan, greater safety and reliability and the like, thus have become indispensible transmission elements in many types of machinery products.

Design and fabrication fineness of gears directly affect the performance and quality of machinery products. Moreover, in order to achieve high quality operation, the gears also need to be finely modified through gear grinding tools. The gear grinding tools, after being used for a number of times, require modification to restore to the required geometric profiles and sharpness.

Many types of gear grinding and modification apparatus are available on the market at present. For instance, U.S. Pat. No. 5,857,894 discloses a gear grinder which comprises a workstation, a work-piece stand, a carrier and a modification device. The work-piece stand is located on the workstation to hold a gear. The carrier is located on the workstation and includes a linear slider, a transverse slider located on the linear slider and a grinding wheel located on the transverse slider to grind the gear. The modification device is located on the workstation at one side opposing the carrier and remote from the work-piece stand, and includes a shaft and a trimming wheel rotated by the shaft. The grinding wheel can be moved horizontally through the carrier to approach the work-piece stand to do grinding operation on the gear. When the grinding wheel is needed to be modified, the carrier is turned to face the modification device such that the grinding wheel can be modified by the trimming wheel.

However, on the gear grinding and modification apparatus mentioned above, the carrier has to meet requirements of moving horizontally and turning, hence mechanism design is complex and more costly. In addition, with the work-piece stand, carrier and modification device all mounted onto the workstation, the workstation has to provide a large table surface, as a result, the gear grinding and modification apparatus is bulky in size. All these leave a lot of room for improvement.

### SUMMARY OF THE INVENTION

The primary object of the present invention is to solve the problems of the conventional gear grinding and modification apparatus of higher fabrication cost and bulkier size.

To achieve the foregoing object, the present invention provides a gear grinding apparatus that provides tool modification function. It comprises a work-piece stand, a tool stand, a grinding wheel assembly and a modification assembly.

The work-piece stand includes a first shaft to hold and rotate an unmodified gear. The tool stand is located at one side of the work-piece stand and movable along a first axial direction against the work-piece stand, and includes a slide member movable along a second axial direction perpendicular to the first axial direction. The grinding wheel assembly is located on the slide member to grind the unmodified gear. The modification assembly is located on the slide member above the grinding wheel assembly and includes a rotary member rotatably mounted on the slide member and having a second shaft rotatable about an axis intersecting the second axial direction at an angle smaller than ninety degrees, a trimmer and a movable arm interposed between the rotary member and trimmer.

The trimmer has an oblique deviation displacement and a tool modification displacement. In the oblique deviation displacement, the grinding wheel assembly is in contact with the unmodified gear to perform machining, and the rotary member drives the movable arm to move the trimmer away from the grinding wheel assembly. In the tool modification displacement, the grinding wheel assembly is moved away from the unmodified gear and the rotary member drives the movable arm to move the trimmer in contact with the grinding wheel assembly to perform modification.

Thus, the invention, by positioning the grinding wheel assembly and modification assembly on the tool stand, can save the use area of one workstation of the gear grinding apparatus, and consequently can shrink the size of the gear grinding apparatus. In addition, by placing the modification assembly above the grinding wheel assembly, the trimmer can be driven merely by the rotary member to contact with the grinding wheel assembly to perform modification. Hence the tool stand does not need rotation function. The structure is simpler and production cost can be reduced.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1A is a perspective view of an embodiment of the invention.

FIG. 1B is a schematic side view of an embodiment of the invention.

FIG. 2A is a schematic of an embodiment of the invention showing the oblique deviation displacement.

FIG. 2B is a schematic of an embodiment of the invention showing the tool modification displacement.

### DETAILED DESCRIPTION OF THE PREFERRED EMBODIMENT

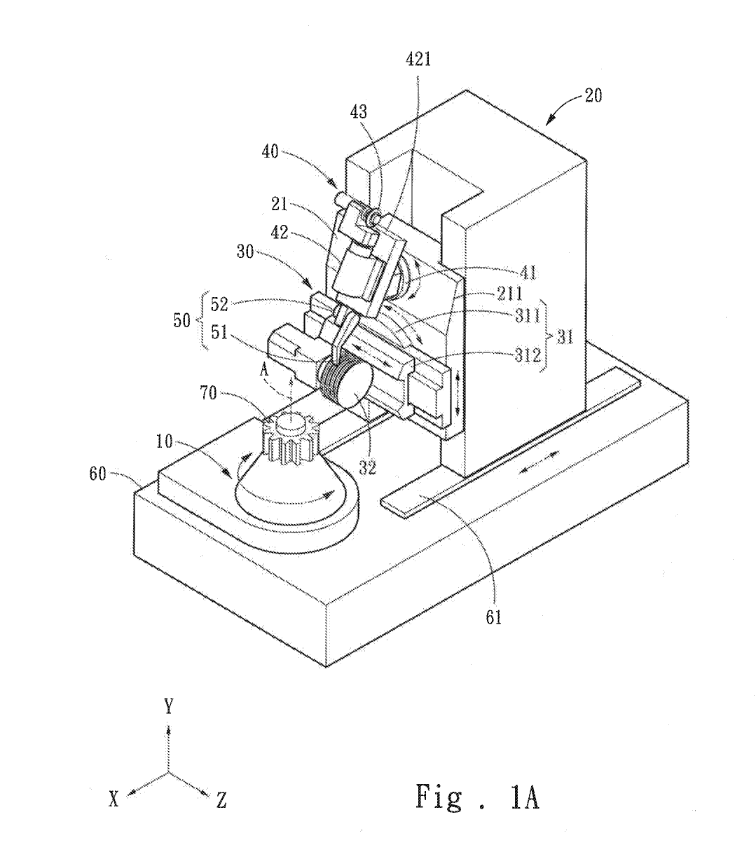

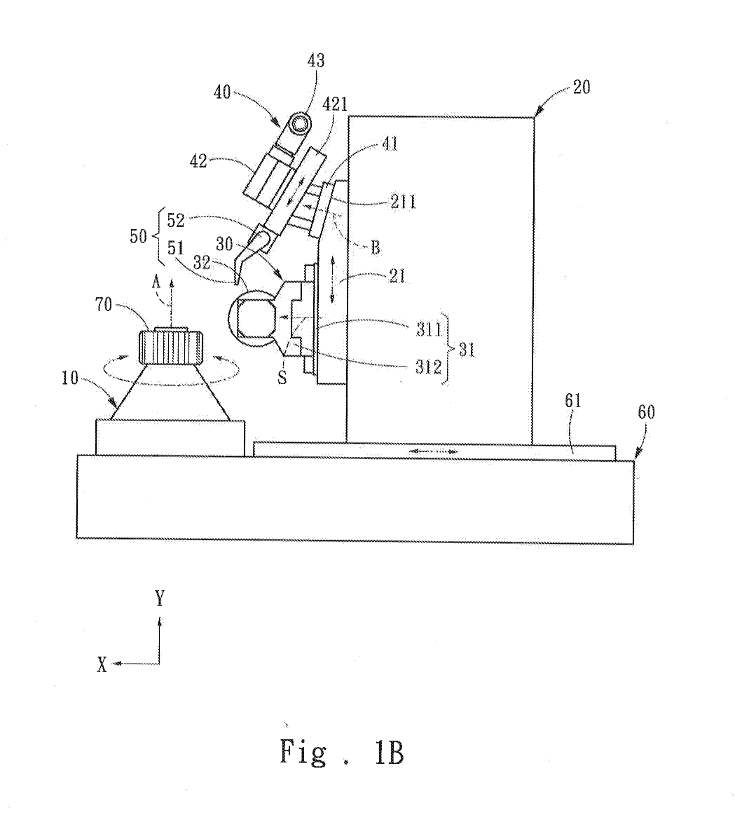

Please refer to FIGS. 1A and 1B, the present invention aims to provide a gear grinding apparatus that offers tool modification function. It comprises a work-piece stand 10, a tool stand 20, a grinding wheel assembly 30 and a modification assembly 40.

The work-piece stand 10 includes a first shaft A to hold an unmodified gear 70. The unmodified gear 70 is rotated with the first shaft A. In this embodiment, the gear grinding apparatus also includes a workstation 60. The work-piece stand 10 is located on the workstation 60 which has a slide track 61. The slide track 61 is formed along a first axial direction X toward the work-piece stand 10. The tool stand 20 is located on the slide track 61 at one side of the work-piece stand 10 abutting thereof and movable along the first axial direction X through the slide track 61 close to or remote from the work-piece stand 10. The tool stand 20 includes a slide member 21 movable along a second axial direction Y perpendicular to the first axial direction X.

The grinding wheel assembly 30 is located on the slide member 21 to grind the unmodified gear 70. In this embodiment the grinding wheel assembly 30 further includes a grinding wheel 32 and a movable member 31. The grinding wheel 32 in this embodiment is a circular disk that can be, but not limited to, an emery wheel. The grinding wheel 32 can have a jutting grinding rim extended radially from the perimeter thereof. The grinding rim can be conical in shape and symmetrical on the left side and right side. The movable member 31 bridges the slide member 21 and grinding wheel 32 to drive the grinding wheel 32, and includes an oscillating element 311 and a transverse movement element 312. The oscillating element 311 is rotatably mounted on the slide member 21 and has an oscillating shaft S perpendicular to the first shaft A, and can oscillate about the oscillating shaft S at angles between +45.degrees and −45.degrees. The transverse movement element 312 is located on the oscillating element 311 and movable therewith. The transverse movement element 312 is also movable against the oscillating element 311 along a third axial direction Z which is perpendicular to the first axial direction X and the second axial direction Y.

The modification assembly 40 is located on the slide member 21 with an inclined surface 211 above the grinding wheel assembly 30, and includes a rotary member 41, a movable arm 42 and a trimmer 43. The rotary member 41 is rotatably mounted on the inclined surface 211 and has a second shaft B rotatable about an axis intersecting the second axial direction at an angle smaller than ninety degrees and crossing the first shaft A in a non-perpendicular manner. The movable arm 42 is located on the rotary member 41 and moved therewith, and includes a linear movement element 421 connected to the rotary member 41 to allow the trimmer 43 connected to the movable arm 42 to move linearly against the rotary member 41. In addition, in this embodiment, the gear grinding apparatus further includes a cutting liquid duct 50 connected to the linear movement element 421. The cutting liquid duct 50 includes a nozzle 51 and a shaft 52. The nozzle 51 is extended in a direction remote from the trimmer 43. The nozzle 51 oscillates about the third axial direction Z via the axle 52.

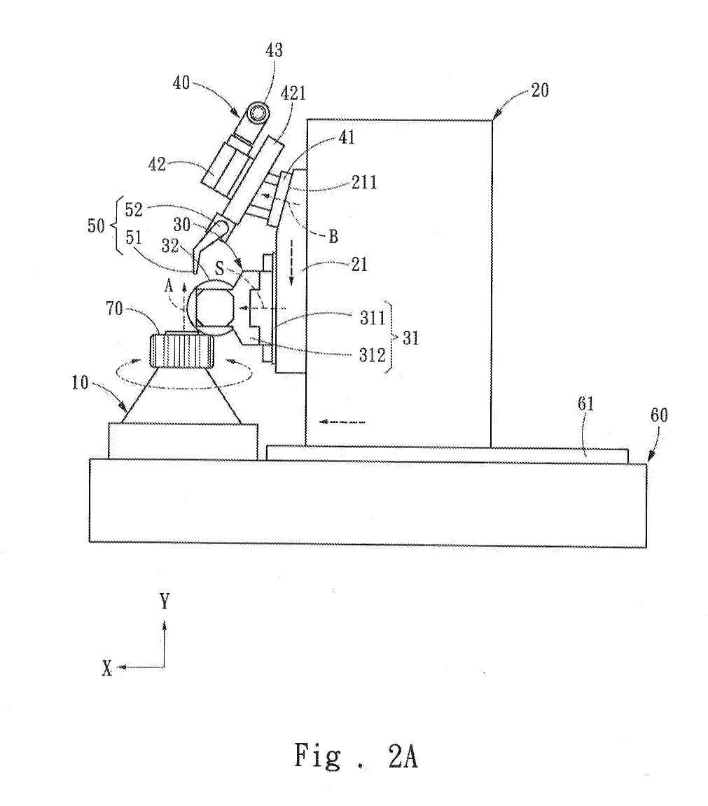

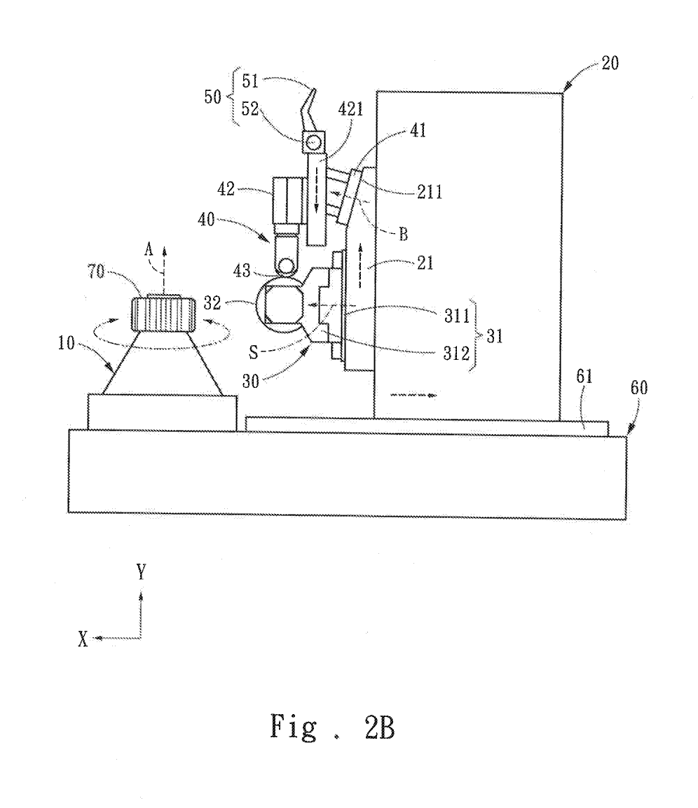

Please refer to FIGS. 2A and 2B for an embodiment of the invention in use conditions, with FIG. 2A showing the oblique deviation displacement, and FIG. 2B showing the tool modification displacement. As shown in FIG. 2A, when the grinding wheel assembly 30 is to perform grinding operation on the unmodified gear 70, it is driven by the tool stand 20 and slide member 21 to move along the first axial direction X and second axial direction Y, such as moving horizontally and downwards to approach the unmodified gear 70; then, the machining position and angle of the grinding wheel 32 when in contact with the unmodified gear 70 is further adjusted through the transverse movement element 312 and oscillating element 311; meanwhile, in the modification assembly 40, the rotary member 41 drives the movable arm 42 with an arm. length to rotate about the second shaft B, and drives the trimmer 43 in an oblique circular movement to move away from the grinding wheel assembly 30, thus forms the oblique deviation displacement of the trimmer 43. Moreover, in the oblique deviation displacement, the cutting liquid duct 50 is moved toward the grinding wheel 32 due to rotation of the rotary member 41, hence can provide cutting liquid to aid grinding operation when the grinding wheel 32 grinds the unmodified gear 70. The cutting liquid duct 50 can be adjusted via oscillation of the axle 52 according to the contact position of the grinding wheel 32 and unmodified gear 70 to supply the cutting liquid at a desired angle.

Please refer to FIG. 2B, in the event that the grinding wheel assembly 30 is needed to be modified, the grinding wheel assembly 30 is driven by the tool stand 20 and slide member 21 to move along the first axial direction X and second axial direction Y, such as moving horizontally and upwards away from the unmodified gear 70; then, the desired modified position and angle of the grinding wheel 32 when in contact with the trimmer 43 is further adjusted through the transverse movement element 312 and oscillating element 311; meanwhile, in the modification assembly 40, the rotary member 41 drives the movable arm 42 to rotate about the second shaft B to drive the trimmer 43 to approach the grinding wheel assembly 30 in the oblique circular movement, and then the linear movement element 421 drives the trimmer 43 to move downward along the second axial direction Y toward the grinding wheel 32 to contact therewith to perform modification, thus forms the tool modification displacement of the trimmer 43.

As a conclusion, the invention has the grinding wheel assembly and modification assembly mounted onto the tool stand, hence merely the work-piece stand and a single tool stand have to be provided on the workstation of the gear grinding apparatus. The use area of the workstation can be saved, and the gear grinding apparatus can be shrunk to a smaller size. Moreover, by placing the modification assembly above the grinding wheel assembly, the movable arm of the trimmer can be driven by the rotary member and the linear movement element to move downward to contact with the grinding wheel and directly perform modification thereon on the tool stand. Thus, the tool stand has a simplified structure without providing horizontal movement and rotation functions to reduce production cost. It provides significant improvements over the conventional techniques.

What is claimed is:

1. A gear grinding apparatus providing tool modification function, comprising:
a work-piece stand including a first shaft to hold and rotate an unmodified gear;
a tool stand which is located at one side of the work-piece stand and movable against thereof along a first axial direction, and includes a slide member movable along a second axial direction perpendicular to the first axial direction;
a grinding wheel assembly located on the slide member to grind the unmodified gear; and
a modification assembly which is located on the slide member above the grinding wheel assembly and includes a rotary member rotatably mounted on the slide member and having a second shaft rotatable about an axis intersecting the second axial direction at an angle smaller than ninety degrees, a trimmer and a movable arm interposed between the rotary member and the trimmer;
wherein the trimmer includes an oblique deviation displacement in which the grinding wheel assembly is in contact with the unmodified gear to perform machining and the rotary member drives the movable arm to move the trimmer away from the grinding wheel assembly, and a tool modification displacement in which the grinding wheel assembly is moved away from the unmodified gear and the rotary member drives the movable arm to move the trimmer in contact with the grinding wheel assembly to perform modification.

2. The gear grinding apparatus of claim 1, wherein the grinding wheel assembly includes a grinding wheel and a movable member to bridge the grinding wheel and the slide member.

3. The gear grinding apparatus of claim 2, wherein the movable member includes an oscillating element rotatably mounted on the slide member and having an oscillating shaft perpendicular to the first shaft.

4. The gear grinding apparatus of claim 3, wherein the movable member includes a transverse movement element located on the oscillating element and movable against thereof along a third axial direction which is perpendicular to the first axial direction and the second axial direction.

5. The gear grinding apparatus of claim 1, wherein the movable arm includes a linear movement element located on the rotary member and movable linearly.

6. The gear grinding apparatus of claim 5 further including a cutting liquid duct connected to the linear movement element and having an axle and a nozzle hinged on the linear movement element via the axle and extended in a direction away from the trimmer.

7. The gear grinding apparatus of claim 1, wherein the work-piece stand and the tool stand are located on a workstation abutting each other.

8. The gear grinding apparatus of claim 7, wherein the workstation includes a slide track coupled by the tool stand to allow the tool stand to move along the first axial direction.
